(19) United States
(12) Patent Application Publication
(10) Pub. No.: US 2017/0195132 A1
(43) Pub. Date: Jul. 6, 2017

(54) Data Monitoring/Aggregation For Evaluating Connections Between Networks

(71) Applicant: IIX, Inc., Santa Clara, CA (US)

(72) Inventors: Al Burgio, Morgan Hill, CA (US); Thomas Brian Madej, Hamilton (CA); Joseph Blake Gillman, Phoenix, AZ (US); William B. Norton, Palo Alto, CA (US)

(21) Appl. No.: 14/985,120

(22) Filed: Dec. 30, 2015

(51) Int. Cl. H04L 12/46; H04L 12/751; H04L 12/26

(52) U.S. Cl. CPC H04L 12/46; H04L 43/0817; H04L 45/02

(57) ABSTRACT

Systems and methods are disclosed for collecting data on traffic paths between networks over an intermediate set of network elements, which may include a Distributed Internet Exchange Platform (DIXP) enabling a peering relationship between the two networks. A set of agents may be coupled with different network elements in the intermediate set from which they may collect data with which the traffic paths may be assessed, monitored, and/or evaluated. The set of agents may report the data to a control-plane module, which may store the data in a centralized database. Additionally, the control-plane module may be operable to generate and/or provision instructions to the agents to control the collection of data and/or the monitoring of traffic paths. The database may include network-topology information from which the control-plane module may identify the traffic paths between the two networks and to which the data may be correlated.

### FIELD OF THE INVENTION

This disclosure relates to networking computing devices and, more particularly, to the interconnection of networks.

### BACKGROUND OF THE INVENTION

An enormous number of computer networks all around the world share interconnections to form the global system that is the internet. To pass traffic between each other, two independent networks often rely on intermediate network elements separate and apart from the two independent networks. Although any network connected to the internet can connect to any other network within the network, in accordance with the end-to-end reachability principle, more direct interconnections between different networks can be desirable for a number of additional reasons, such as increases in capacity, control of traffic, and redundancy and/or cost control.

Connections between networks may be implemented in many different ways. In one example, one or more of the independent networks may pay an intermediate, transitive network for bandwidth between itself and other independent networks and/or for connection to the broader internet. In other examples, a private, network-interconnection, communications link may be installed to directly connect the two networks.

In yet other examples, the independent, separately-administered networks may voluntarily agree to interconnect with one another in a non-transitive relationship where one separately-administered network may have access to the other, separately-administered network, but not to additional networks connected to the two independent networks but external to the two networks. Such relationships are known as peering. Often peering is facilitated by an Internet Exchange Point (IXP). An IXP provides a form of localized physical infrastructure providing opportunities for direct interconnection, such as by one or more switches and or the like, to independent networks providing a connection thereto. However, IXPs are limited in the peering they can facilitate by the physical location at which they provide the infrastructure for interconnections.

Novel solutions to the problem of facilitating peering relationships between geographically-remote, independent networks are described in a patent application with international publication number WO 2014059550 A1, entitled “Method and Apparatus for a Distributed Internet Architecture,” which is incorporated herein by reference. Such solutions may be implemented to interconnect geographically dispersed IXPs over which peering relationships for geographically remote networks may be facilitated. These solutions may be referred to as examples of a Distributed Internet Exchange Platform (DIXP). A DIXP may enable multiple different paths, or routes, between different pairs of independent networks in a peering relationship. Aside from these multiple different types of paths, or routes, enabled by a DIXP, additional approaches, such as, without limitation, those discussed above, can each provide one or more paths, or routes, between two independent networks.

### BRIEF DESCRIPTION OF THE DRAWINGS

In order that the advantages of the disclosures herein will be readily understood, a more particular description will be rendered by reference to specific examples and/or embodiments illustrated in the appended drawings. Understanding that these drawings depict only explanatory examples and/or typical embodiments and are not, therefore, to be considered limiting in scope, the invention will be described and explained with additional specificity and detail through use of the accompanying drawings, in which:

FIG. 1 is a schematic block diagram of several different implementations for providing a connection between two independent networks;

FIG. 2 is a schematic block diagram also depicting several different implementations for providing a connection between two independent networks, also indicating the use of a novel Distributed Internet Exchange Platform (DIXP), in accordance with examples;

FIG. 3 is a schematic block diagram of a DIXP, together with some of the potential different routes and/or paths that such a DIXP may provide for traffic between two independent networks, in accordance with examples;

FIG. 4 is a schematic block diagram of gatekeepers enabling the authentication of networks connected by the DIXP and the exchange of network prefixes and/or routing information, in accordance with examples;

FIG. 5 is a schematic block diagram of the use of a control plane to gather data for a diverse, potentially path-dependent, range of metrics for approaches to connecting two independent networks, including approaches involving a DIXP, and to store the data in a centralized database, where the data may be used to assess, monitor, and/or evaluate multiple different paths, or routes, between the two independent networks, in accordance with examples;

FIG. 6 is a schematic block diagram of a potential distribution of agents for the collection of data within intermediate networking infrastructure, in accordance with examples;

FIG. 7 is a schematic block diagram of various features and/or elements of a control-plane module, together with communication links between the control-plane module and a client computer and a third-party system, in accordance with examples;

FIG. 8 is a schematic block diagram of various features and/or elements of an agent in communication with a control-plane module and a network device to collect data from the network device and provide the data to the control-plane module for storage in a database; and

FIG. 9 is a flow chart of steps for collecting data with which to monitor, asses, and/or evaluate different paths and/or routes through intermediate networking infrastructure, in accordance with examples.

### DETAILED DESCRIPTION

It will be readily understood that the components of the present invention, as generally described and illustrated in the figures herein, can be arranged and designed in a wide variety of different configurations. Thus, the following more detailed description, as represented in the figures, is not intended to be limiting in scope, as claimed, but is merely representative of certain examples. The presently described examples will be best understood by reference to the drawings, wherein like parts are designated by like numerals throughout.

The development of Distributed Internet Exchange Platform (DIXP) technologies enables peering relationships between both geographically-proximate, and geographically-remote, independent networks 10. Also, DIXP technology provides the first intensive opportunity for multiple paths and/or routes between independent networks. That opportunity raises questions as to which route/path and/or combination of routes/paths should be selected to transfer traffic over intermediate network architecture between two independent networks at any given time.

Before such questions can be answered, the relevant data needs to be collected. However, such data would need to be collected from intermediate network infrastructure separate and apart from the networking infrastructure of the two independent networks communicating over the intermediate infrastructure. Before pursuing the questions raised by DIXP technologies further, a brief discussion is provided of previous technologies for connecting independent networks.

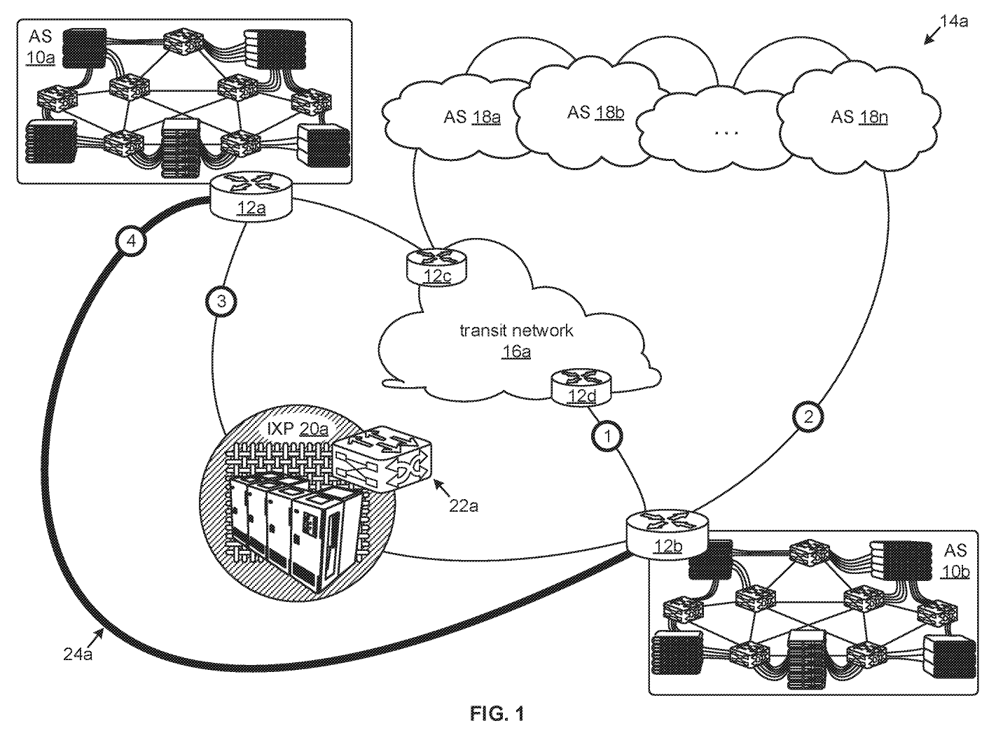

Referring to FIG. 1, a first network, or set of separately-administered networks, 10a and a second network, or set of separately-administered networks, 10b are depicted, together with various approaches for connecting the two networks 10a, 10b. In some, but not necessarily all examples, one or more of the networks, or set of separately-administered networks, 10a, 10b may be an Autonomous System (AS) (herein after “network” “set of separately-administered network,” and/or AS), which may actually include multiple networks, with an Autonomous System Number (ASN), a single administrative entity, and/or a common routing policy that it presents to the internet. Each of the two networks 10a, 10b may have a router, and/or set of routers, 12a, 12b (hereinafter “router” and/or “set of routers”) providing access to the corresponding networks 10a, 10b.

In between the routers 12a, 12b, providing access to the corresponding networks 10a, 10b, various forms of intermediate infrastructure 14a (hereinafter “intermediate infrastructure,” “intermediate network elements,” “intermediate network devices,” and/or “intermediate network nodes”) are depicted that are operable to connect the two networks 10a, 10b. For example, a first path for passing traffic between the two independent networks 10a, 10b may be enabled by a transit network 16a (hereinafter “transit network,” and/or “transit provider”). As discussed, one or more of the two networks 10a, 10b may purchase bandwidth from the transit provider 16a. In this first path type (1), the transit network 16a may direct traffic between the routers 12a, 12b of the two networks 10a, 10b via a series of internal switches, routers 12, and or the like that are connected to one another via one or more network communications links at the discretion of the transit provider 16a.

In a second path type (2), also potentially involving the transit provider 16a, the transit provider 16a may route traffic between the two networks 10a, 10b via one or more additional networks 18a-n, which may or may not also be transit providers 16, in series. In such examples, the path, or route, of the traffic may be subject to the control of the transit provider 16a and/or the series of additional networks traversed 18a-n. In some scenarios, the transit provider 16, and/or its limitations, may determine whether or not traffic is passed in accordance with the first path type (1) or the second path type (2).

In other scenarios, this decision may be made by the network, or networks, 10 paying for the transit. In some cases whether the passing of traffic is performed in accordance with the first path type (1) or the second path type (2), may result in differing costs, services, and/or performance metrics. For instance, approaches consistent with the first path type (1) may, where traffic is handled internally within the transit provider 16a, entail a level of control that may allow the transit provider 16a to offer certain guaranties with respect to quality of service and/or the like.

The use of a peering relationship, as facilitated by an Internet Exchange Point (IXP) 20a, provides a third path type (3). The IXP 20a may provide localized infrastructure for a direct, physical connection between the two networks 10a, 10b engaged in the peering session, rather than through one or more third-party networks 16/18. An IXP 20a may include switch fabric implemented at one or more Ethernet-based Local Area Network (LAN) switches 22a housed in a single location or interconnected across multiple proximately located sites. The IXP 20a may operate in a layer-2 configuration and/or may utilize an Internet Protocol (IP) subnet for the connection of participating ASs 10. Examples of such an IXP 20 may include a data center or collocation center, where the costs of the infrastructure may, for example, be shared by the participants. An IXP 20 may provide a switch, or system of switches, 22a to which networks 10a, 10b participating in the IXP 20 may connect.

Consequently, upon agreement between participating parties, the switch, or system of switches, 22 may be configured to provide a physical interconnection between networks 10a, 10b. An IXP 20 provides advantages in terms of allowing separately-administered networks 10a, 10b to interconnect directly, with a peering session, rather than through one or more third-party networks 16/18 with their accompanying costs. However, the geographic constraints imposed by the location of a IXP 20 prevent the approach from providing connections between geographically remote locations.

As yet another non-limiting path type, in a fourth path type (4), a private, network-interconnection, communication link 24a may be installed to directly connect the two separately-administered networks 10a, 10b. The private, network-interconnection link 24a may be implemented with any number of technologies, such as, without limitation, copper cabling, fiber-optic cabling, microwave channels, and/or satellite links. Even more so than with the transit based approaches discussed above, this fourth path type (4) can be expensive, often prohibitively expensive, especially where long distances and/or bandwidths are involved.

As can be appreciated, where an investment is made to address communication needs between two networks with a private link 24, little attention may be paid to other approaches. Similarly, where payments are made for transit, little attention may be given to other approaches. Although traffic may traverse many different paths through a transit network 16 and/or additional networks 18a-n, each of such networks 16/18a-n is essentially a black box, the interworking of which is left to the administrators of such networks 16/18a-n, making the decision to use such an approach substantially equivalent to the selection of a single path.

Consequently, little attention has been paid to optimizing traffic paths and/or networks through such intermediate infrastructure. Additionally, each of these path types has its own set of disadvantages, such as, without limitation, cost, lack of control, and geographic limitations, among others. However, novel technologies may be developed to mitigate and/or remove at least some of such disadvantages, while providing multiple potential paths through the intermediate networking elements.

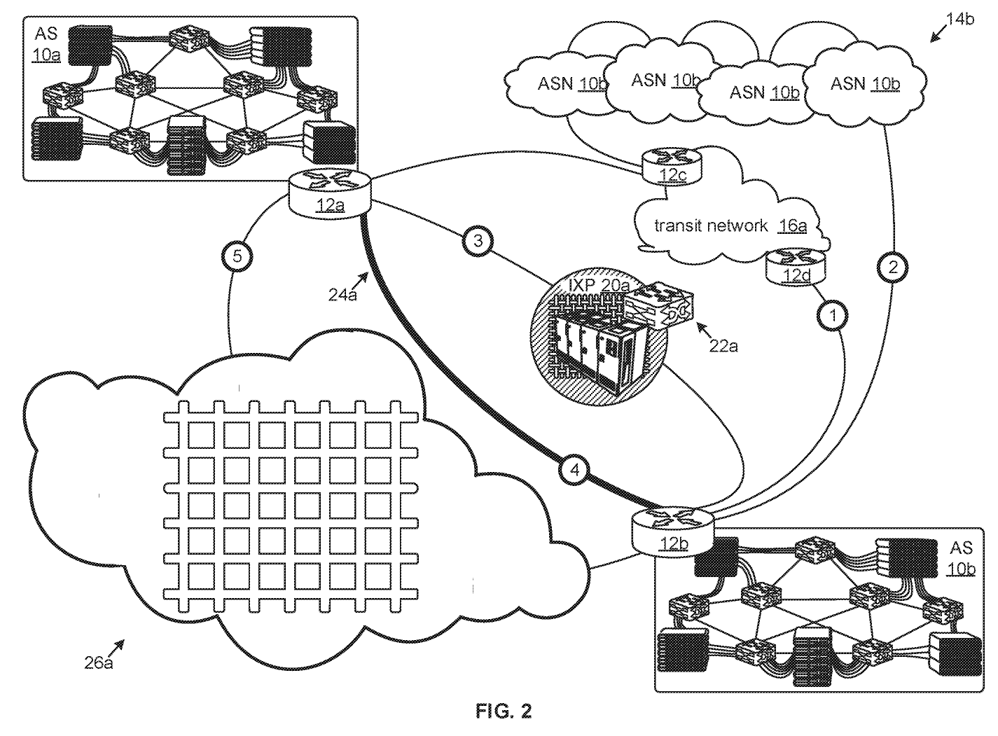

Referring to FIG. 2, the two sets of separately-administered networks 10a, 10b are again depicted with intermediate infrastructure 14b. In FIG. 2, however, a DIXP 26a is also depicted among the intermediate infrastructure 14b. In some examples, the two independent networks 10a-b may be connected solely by means of the DIXP, or grid of IXPs, 26a. However, the two networks 10a, 10b may maintain potential connections with any combination of the four path types discussed above, over a transit network 16a, additional networks 18a-n, an IXP 20a, a private link 24a, and/or a fifth path type (5), over the DIXP 26a, and/or the like. Additional details of the DIXP path type relevant to the disclosures herein are discussed with respect to the following figure.

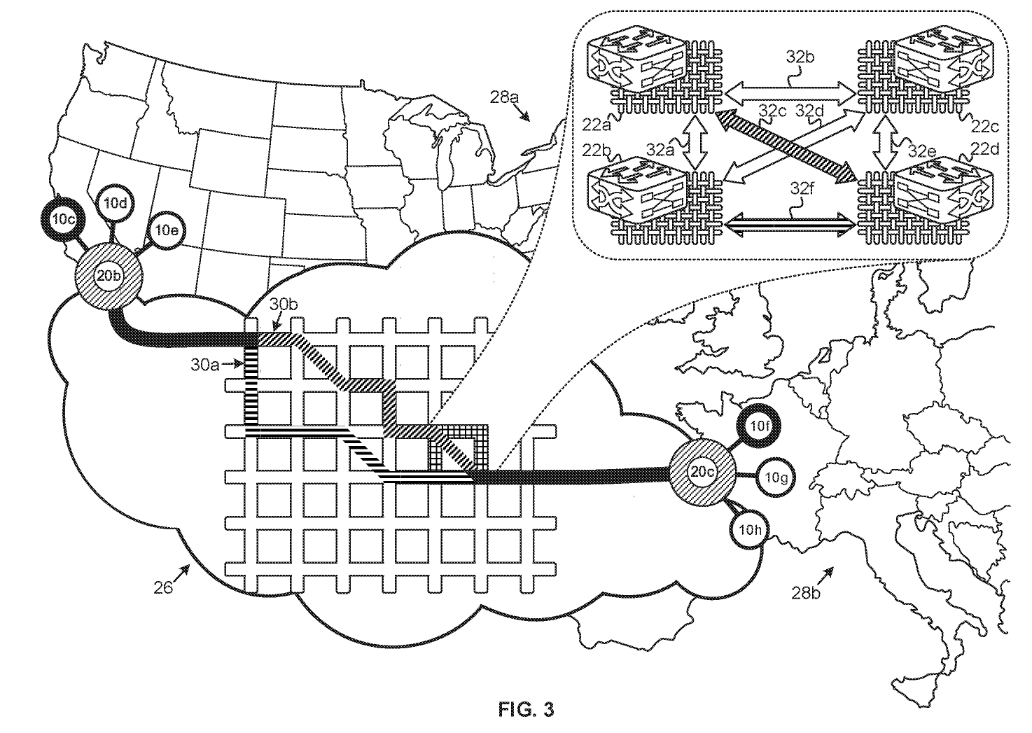

Referring to FIG. 3, an implementation of a DIXP 26a is depicted, highlighting the advantageous of a DIXP 26 in implementing peering relationships irrespective of the geographic location of the networks 10c-h participating in those peering relationships. As depicted, peering relationships may be entered into whether participating networks are remotely located at different ends of a continent 28a, or even on different continents 28a, 28b.

A DIXP 26a may interconnect multiple IXPs 20b-c at different geographic locations. The DIXP 26a may include a number of routers 12, switches 22, and/or the like that serve as nodes in a mesh, or other topology, operable to carry traffic between two independent networks 10c, 10f, such as a network 10c located in San Francisco and a network 10f located in Paris. The two networks 10c, 10f may be connected to different IXPs 20b, 20c serving different geographic locations, which, in turn, may be connected by a number of routers 12, switches 22, and/or the like provided by the DIXP 26a to carry traffic between IXPs 20.

As depicted, multiple different traffic paths 30 (hereinafter paths and/or routes) are possible between the two IXPs 20b, 20c to which the two independent networks 10c, 10f being connected are also connected, regardless of the layer-2 protocol used. Although two paths 30a, 30b are depicted between the two IXPs 20b, 20c, any number of different paths 30 are possible. The possible variety of routes 30 is further highlighted by the inset depiction of an enlarged portion of the DIXP 26a, for which multiple geographically dispersed instances of switching fabric 22a-d are depicted. Although the depicted DIXP nodes are made up of instances of switching fabric 22a-d, routers 12 and/or other types of nodes may be relied upon. The wide range of directionality provided by the bidirectional links 32a-f instances of switching fabric 22a-d highlights the diverse possibilities for connection paths 30.

A DIXP 26 may employ various algorithms, standards, and/or protocols to the geographically diverse switches 22a-d. Examples may include, without limitation: Shortest Path Bridging (SPB), as defined by IEEE 902.1aq and/or various updates; Transparent Interconnection of Lots of Links (TRILL); Spanning Tree Protocol (STP) as defined by IEEE 902.1D and/or various updates; and/or other such layer 2 protocols. In examples reliant on protocols resulting in a single active path between any given pair of network devices, such as STP, active paths may be deactivated and deactivated paths may be activated, to create different potential paths through such a DIXP 26. In examples reliant on protocols resulting in multiple active paths between any given pair of network devices, such as SPB and TRILL, those multiple active paths may be harnessed, as discussed below.

These or routes 30 may pass between the two IXPs 20b, 20c for transmission to the two independent networks 10c, 10f while being contained within the DIXP 26a. Superficially, the containment of these paths 30 within the DIXP 26a may appear similar to the way in which traffic, between independent networks 10a, 10b, may be contained within the transit network 16a pursuant to the first approach described above. However, there are fundamental differences between transit networks 16 and DIXPs 26 and the kinds of connections they are designed to provide and the nature of the traffic and traffic paths that they are designed to handle.

Consistent with the principle of end-to-end-reachability principle behind the internet, a transit relationship between a network 10 and a transit provider/network 16 is designed to provide upstream connections to the network 10 that serve to connect the independent network 10 with the rest of the internet. Conversely, the peering relationships enabled by a DIXP 26 provide a direct connection between the two networks 10, disregarding connections to other networks providing access to the broader internet.

As a result, the nature of the traffic and/or traffic paths that transit networks 16 and/or DIXPs 26 can anticipate may vary greatly, resulting for differing opportunities. The traffic experienced by the DIXP, belonging to a direct connection between two networks 10c, 10d, is more analogues to the flow in a major artery. The traffic experienced by the DIXP 26, belonging to a direct connection between two networks 10c, 10d, is more analogues to the flow along a major artery. The traffic experienced by a transit-provider network 16 is anticipated to be more like the flows carried in branching capillaries to all different parts of the internet.

The development of DIXPs 26, together with insights into the nature of the kinds of connections and traffic flows involved in the peering relationships they enable, as opposed to the transit relationships enabled by transit networks 16, provide an opportunity to improve the peering relationships between networks 10c, 10f. For example, decisions may be made to better utilize the infrastructure of a DIXP 26 and/or other path types, such as those discussed above, to improve the paths 30 connecting networks 10. To facilitate making such determinations, appropriate data sets, informed by the nature of the various approaches discussed above to connecting networks 10, particularly in light of the peering relationships enabled by DIXP technologies 26, may be provided.

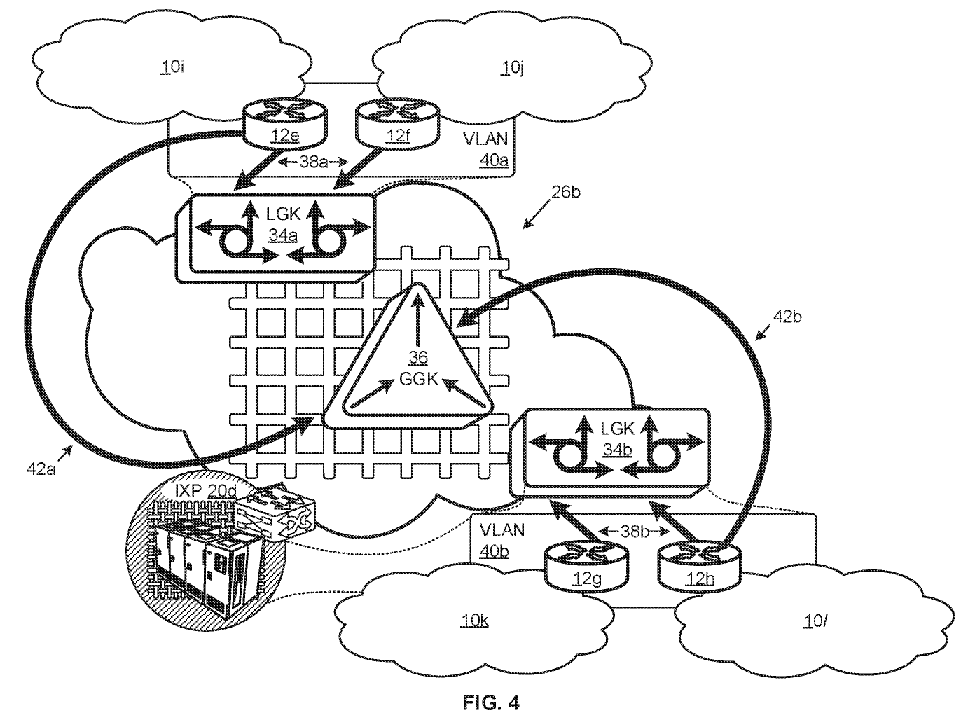

Referring to FIG. 4, a DIXP 26 is depicted with infrastructure capable of satisfying the control-plane requirements for connections between networks 10. In addition to the physical connections over which data may be carried in the data plane, connections between networks 10 may rely on routing information, authentication to insure security of the routing information, and or the like, as may be provided in the control plane.

In the previous examples involving a transit network 16, additional networks 18a-n, a standalone IXP 48, and/or a direct connection 24b, such information may be provided, without limitation, through the advertisement of network prefixes, authentication information, and/or other routing information from the routers 12a, 12b associated with the networks 10 being connected. In the examples involving a standalone IXP 48 and/or a direct connection 24b the routers 12 may employ a protocol, such as, without limitation, Border Gate Protocol (BGP) to directly communicate information and/or authenticate. With respect to physical connections provided over a transit network 16 and/or additional networks 18a-n, the respective independent/separately-administered/AS networks 10 connected thereby can introduce latency with the time involved in finding each other and going through an authentication process.

Conversely, a DIXP 26b may be provided with one or more Local Gate Keepers (LGK) 34a, 34b and/or one or more Global Gate Keepers (GGK) 36. The LGKs 34a, 34b and/or the GGK 36 may run an inter-autonomous system routing protocol, such as, by way of example and not limitation, a Border Gateway Protocol (BGP), such as, without limitation, exterior BGPv4. The inter-autonomous system routing protocol may be able to import and/or export/advertise network prefixes, whether IPv4 or IPv6, and/or routing information, and/or authenticate networks 10.

One or more routers 12e, 12f and 12g, 12h pertaining to networks 10i, 10j and 10k, 10l sharing a common locality or physical point of access may advertise network prefixes, whether IPv4 or IPv6, and/or routing information and or be authenticated by one or more LGKs 34a, 34b. Similarly, the corresponding networks 10a, 10b and 10c, 10d may receive, over the control plane, and/or trust network prefixes and/or routing information originally advertised by other networks 10 connected to and/or authenticated by a corresponding LGK 34.

Hence, an LGK 34 and/or, as discussed below, a GGK 36, may allow for multilateral peering sessions between multiple networks 10, requiring minimal configuration at corresponding routers 12. The networks 10 connected 38a, 38b to and/or authenticated by a corresponding LGK 34 may, therefore, form a Virtual Local Area Network (VLAN) 40. In some examples, an LGK 34 may correspond to an IXP 20d connected to the DIXP 26b and the corresponding VLAN 40b may cover networks 10c, 10d connected to the DIXP 26 via the IXP 20d.

Additionally, or in the alternative, one or more routers 12e, 12h pertaining to multiple networks 10i, 10l connecting to the DIXP 26b, regardless of their geographic location, may connect, or establish a session with, 42a, 42b one or more GGKs 36. The geographically-dispersed, connected 10i, 10l may also advertise net prefixes and/or routing information, and/or be authenticated by one or more GGKs 36. As with an LGK 34, the geographically-dispersed networks 10i, 10l may receive and/or trust net prefixes and/or routing information advertised by other geographically-dispersed networks 10 connected to and/or authenticated by a corresponding GGK 36.

By way of example, and not limitation, an independent/separately-administered/AS networks may connect with an LGK 34 and/or a GGK 36 by establishing a BGP session with the LGK 34 and/or a GGK 36. Further explanation of DIXP technology may be found in the patent application with international publication number WO 2014059550 A1, entitled “Method and Apparatus for a Distributed Internet Architecture,” which is incorporated herein by reference.

Consequently, and advantageously, networks 10 may establish a single connection with an individual LGK 34 and/or a GGK 36 to be authenticated for, advertise network prefixes and/or routing information to, and/or receive advertise network prefixes and/or routing information from the networks 10 connected to the LGK 34 and/or a GGK 36. Such services may be provided whether the participating networks 10a are local to an IXP 20 or are more geographically remote. Such services also may be capitalized to obviate the need to build multiple transport networks with individual networks 10.

Advantageously, such approaches may lower latency for peering networks 10, provide alternative paths 30 for remote networks 10 and/or minimize single points of failure. The use of multiple LGKs 34 and/or GGKs 36 may also provide multiple peer connectivity options by using sub-interfaces that logically separate the LGK and/or GGK traffic. The control plane, not only of the DIXP 26, but of additional intermediate infrastructure 14 may also be used to collect data on and/or monitor different potential paths 30 between networks 10a.

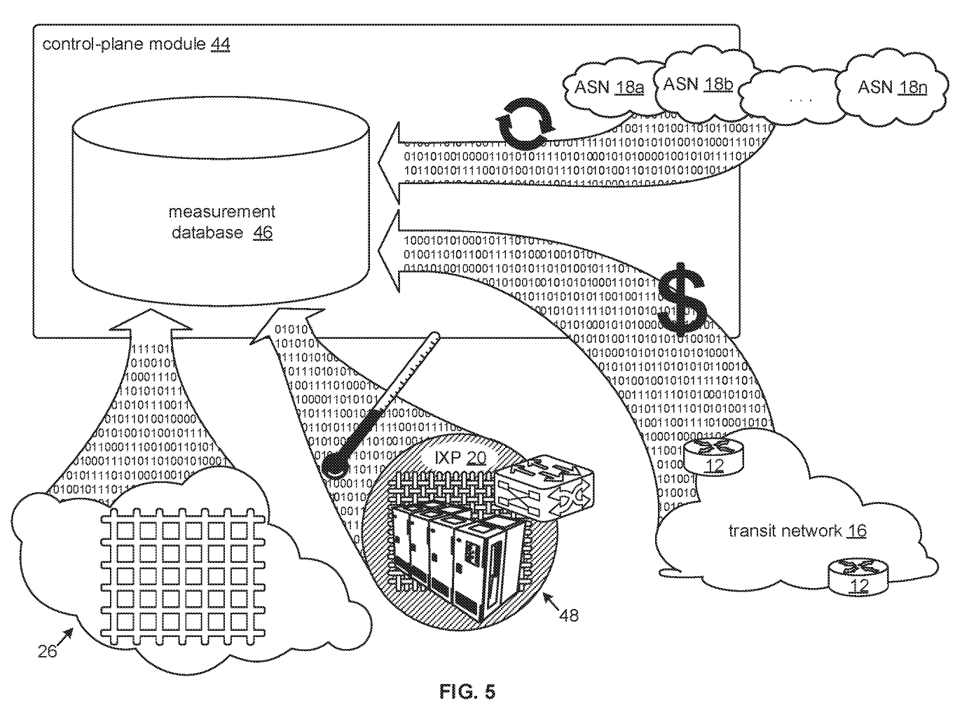

Referring to FIG. 5, a control-plane module 44 is depicted. Throughout this application, the structure and/or functionalities discussed herein may be described as being provided by, occurring at, and/or handled by modules. Modules may take the form of an entirely hardware embodiment, an entirely software embodiment (including firmware, resident software, micro-code, etc.), or an embodiment combining software and hardware aspects. Furthermore, aspects of the presently discussed subject matter may take the form of a computer program product embodied in any tangible medium of expression having computer-usable program code.

With respect to software aspects, any combination of one or more computer-usable or computer-readable media may be utilized. For example, a computer-readable medium may include one or more of a portable computer diskette, a hard disk, a Random Access Memory (RAM) device, a Read-Only Memory (ROM) device, an Erasable Programmable Read-Only Memory (EPROM or Flash memory) device, a portable Compact Disc Read-Only Memory (CDROM), an optical storage device, and a magnetic storage device. In selected embodiments, a computer-readable medium may comprise any non-transitory medium that may contain, store, communicate, propagate, or transport the program for use by or in connection with the instruction execution system, apparatus, or device.

Computer program code for carrying out operations of the present invention may be written in any combination of one or more programming languages, including an object-oriented programming language such as C++, and conventional procedural programming languages, such as the “C” programming language, or similar programming languages. Aspects of a module that are implemented with software may be executed on a micro-processor, Central Processing Unit (CPU) and/or the like. Any hardware aspects of the module may be implemented to interact with software aspects.

The control-plane module 44 may collect data for storage in a measurement database 46. In so doing, the control-plane module 44 may collect data with which multiple different potential routes 30 between networks 10 may be monitored and/or assessed. Furthermore, the control-plane module 44 may store the data in a centralized database 46, which may be maintained on a physical storage medium, such as, without limitation, one or more RAM device(s), one or more solid state memory devices, and/or one or more hard drives.

The control-plane module 44 may, for example, collect data from a DIXP 26 and/or multiple IXPs 20 participating in the DIXP 26. In some examples, the control-plane module 44 may collect data from one or more standalone IXPs 48, as it may collect data from other forms of intermediate infrastructure 14. In such examples, a control-plane module 44 may collect measurements relevant to hardware health for hardware in the standalone IXPs 48, as indicated by the thermometer icon.

By way of non-limiting examples of such quantifiable, hardware-health measurements, data on the status of hardware, router available memory, power supply status, fan status, CPU temperature, hardware temperature, ambient temperature, and/or the like may be collected. Such data may include data that may contribute to an overall picture of the “global health” of one or more systems that may facilitate a route between independent networks 10. Although some or all of such data about the hardware and environment may not be immediately relevant to the performance of a particular path 30, such data may, by way of a non-limiting example, assist a network administrator in predicting possible hardware failures. Also, although FIG. 5 highlights standalone IXPs 48 for hardware-health measurements, such measurements may also be taken for other intermediate infrastructure 14.

In some examples, the control-plane module 44 may collect data from one or more transit networks 16. In such examples, a portion of such data may include information about costs involved with using the transit network(s) 16, as indicated by the dollar icon. By way of another, non-limiting example of transit-network data, such data may include information about service guaranties, agreement provisions, and/or the like.

The control-plane module 44 may also collect data relevant to other networks 18/16 that may facilitate interaction between independent networks 10. Owing to limited access to such networks 18/16, the data that may be collected may be subject to certain limitations. However, information about the use of such networks 18/16 to connect independent networks 10 may be collected indirectly, such as by way of independent networks 10 measuring data communicated between each other over such networks 18/16, as indicated by the icon with the circling arrows.

Consequently, the database 46 may be operable to maintain data for different metrics specific to different path types having a potential to facilitate traffic passing between networks 10. Such data may provide information on network devices 14 outside of the networks 10 between which traffic is being passed. The following discussion provides a brief, non-limiting overview of approaches to collect data for monitoring, assessing, and/or determining paths 30 between independent networks 10 over intermediate networking infrastructure 14.

By way of a non-limiting example, a system for data collection for potential traffic paths 30 between networks 10 may include, in addition to the control-plane module 44 and database 46 discussed above, a set of agents communicatively coupled to network devices in the intermediate infrastructure 14. The set of agents may be operable to carry out instructions to collect data from the network devices 14 relevant to the evaluation of potential paths 30 for the traffic passing between a first network 10 and a second network 10. In such examples, the control-plane module 44 may be communicatively coupled to both the set of agents and the database 46.

The control-plane module 44 may provision the instructions to the set of agents and/or store the data received from the set of agents in the database 46. Furthermore, in such examples, the database 46 may maintain data correlated to network devices in the intermediate architecture 14 having a potential to facilitate traffic passing between the networks 10. The control-plane module 44 may further be operable to correlate the data to different potential paths 30 for the traffic passing between the first network 10 and the second network 10, wherein the first network 10 may be an AS network 10 and the second network 10 may be an AS network 10.

Also, in some examples, the control-plane module 44 and the set of agents 50a-k may be operable to monitor the network devices by continually updating the instructions, collecting the data, and storing the data in the database 46. Examples may also include at least a subset of the set of agents that may be further operable to collect measurements relevant to hardware health for hardware correlated to the different potential paths 30 for the traffic passing between the first network 10 and the second network 10.

Furthermore, in some examples, some of the intermediate infrastructure 14 and/or potential paths 30 for which data is collected may include and/or pass through a DIXP 26. The DIXP 26 may enable a peering relationship for the traffic passing between the first network 10 at a first geographic location and the second network 10 at a second geographic location remotely located relative to the first geographic location. In some of such examples, the control-plane module 44 may further be operable to provide instructions to the set of agents coupled to network devices 14 that facilitate multiple different potential paths 30 from the first network 10 through the DIXP 26 and/or update the database 46 with the data about the multiple different potential paths 30 collected by the set of agents. Additionally, in such examples, one or more potential paths 30 and/or some of the intermediate infrastructure 14 for which data is collected may include and/or facilitate a path 30 providing an alternative to the one or more paths 30 through a DIXP 26.

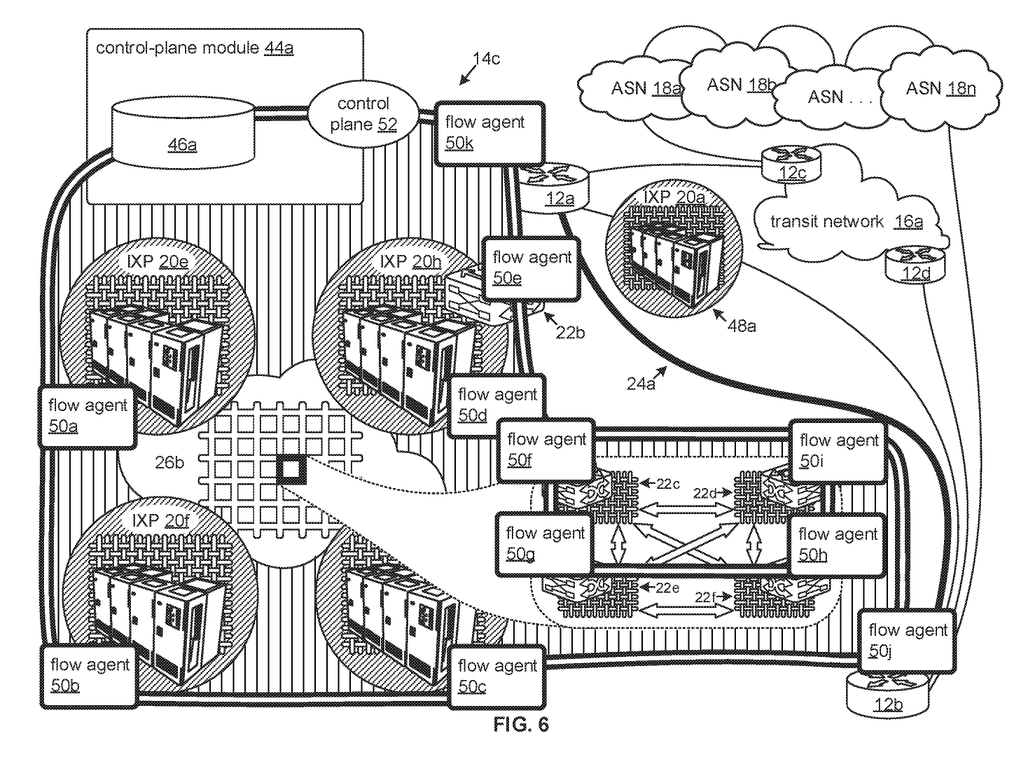

Referring to FIG. 6, agents 50a-k are depicted at intermediate infrastructure 14c. Inasmuch as a DIXP 26b may include multiple network devices within the intermediate infrastructure 14c, multiple agents 50a-k may be communicatively coupled to these various network devices, or groups of network devices, at various locations and/or at network devices of, potentially, differing types. For example, one or more agents 50a-e may be communicatively coupled to networking nodes and/or hardware at one or more IXPs 20b-e interconnected by the DIXP 26b. Such agents 50 may collect traffic data, which by way of example and not limitation may include data on metrics that may include bandwidth cost, network latency, jitter, packet loss rate and network reachability, and/or data on other associated performance and health metrics.

As depicted with respect to the interconnected IXP 20e at the upper right hand corner of the DIXP 26b, one or more agents 50e may be communicatively coupled to the fabric switch(es) 22b of the IXP 20e. Additionally, one or more agents 50d may be communicatively coupled to other aspects of the IXP 20e so as to, without limitation, collect hardware-health data, as discussed above. Also, additional agents 50f-i may be communicatively coupled to geographically dispersed instances of switching fabric 22c-f in the DIXP 26b, applicable for interconnecting the IXPs 20b-e.

Additional networks, like a transit network 16a, and/or additional networks 18a-n, may be separately administered relative to the DIXP 26b. However, one or more additional routers 12e, 12f, or other network devices, may be connected to such a transit network 16a, and/or additional networks 18a-n. Such additional routers 12e, 12f may be under a common administrator, or group of administrators, with the DIXP 26b. As a result, agents 50j, 50k may also be communicatively coupled to these routers 12e, 12f. Additionally, one or more standalone IXPs 48a not interconnected via the DIXP 26b may, or may not, have one or more agents 50 communicatively coupled to corresponding switching fabrics 22c-f and/or other hardware pertaining to the one or more standalone IXPs 48a. Generally speaking, agents 50 may be placed at any hub, switch 22, router 12 or other network device in the topology where traffic and other associated performance and health metrics may be monitored. As depicted in FIG. 6, agents 50 may be placed to collect data on any of the potential paths 30 that may be used to connect independent networks 10, including, but not limited to, paths 30 traversing the DIXP 26b.

A single control plane 52 may connect some or all of the agents 50 within the system. Consequently, some or all of the network devices and/or nodes whose behaviors may affect each other may be under the control of a common control-plane module 44a via the control plan 52. The control-plane module 44a may be connected to these agents 50 through a reliable, common communications channel facilitating the control plane 52, which may support an AS network. Some of these connections facilitating the control plan 52 may be made over a DIXP 26b.

The control-plane module 44a may communicate instructions to the agents 50 about what data to collect and/or how to collect such data over the control plane 52. The agents 50 may communicate collected data to the control-plane module 44 over the control plane 52. Functionalities of a control-plane module 44 in the collection, aggregation, and/or monitoring of such data and/or information are described below with help from the following figure.

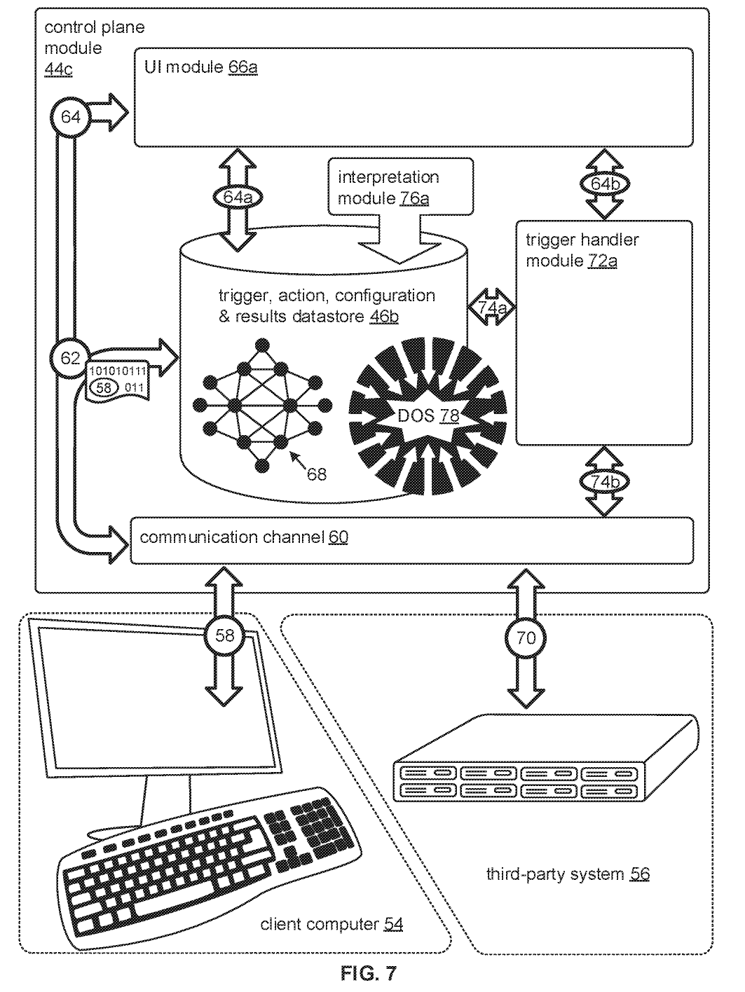

Referring to FIG. 7, various features and/or elements of a control-plane module 44 are depicted. Also depicted are a client computer 54 and a third-party system 56. The control-plane module 44 may be located at one or more network devices within the intermediate infrastructure 14 and/or at one or more independent computing devices, such as, without limitation, one or more servers.

As discussed, the control-plane module 44 may be communicatively coupled to a database, or datastore, 46b. As also discussed, with respect to FIG. 5, the database/datastore 46a may maintain, without limitation: traffic data; hardware-environment measurements; transit costs; QoS guarantee information; transit agreement details; indirect measurements, such as ping-type measurements; and/or the like. The control-plane module 46b may receive such information from agents 50 distributed across the intermediate infrastructure 14, via, by way of example and not limitation, reports, or messages, 58 sent to and/or received by the control-plane module 44c over a communication channel 60 within the control plane 52.

The control-plane module 44c may store 62 the information from such reports/messages 58 in the database, or datastore, 46. The control-plane module 44c may store 62 such information in a relational, topological, spatial, time-series, and/or the like, database format. Any computer readable format may be used, including but not limited to, binary data in any type of encoding or format, a proprietary data format, and/or the like. Also, or in the alternative, any human readable format may be used, including but not limited to, Comma/Tab Separate Values (CSV/TSV), eXtensible Markup Language (XML), Javascript Object Notation (JSON), and/or the like.

Additionally, or in the alternative, in some examples, a client computer 54a may be used by an administrator and/or user to input, or program, 64a data into the database 46b. Such a client computer 54a may have a link 58 to a communication channel 60, within the control plane 52, accessed by the control-plane module 44c. The control-plane module 44c may receive such information from the client computer 54a, such as, without limitation, via a User Interface (UI) module, or input module, 66 (hereinafter UI module and/or input module) within and/or communicatively coupled with the control-plane module 44c.

The UI module 66 may be operable to provide an interface to prompt the input and/or the reception of such data in the database 46b. The input/UI module 66 may, for example and without limitation, receive data relevant to the evaluation for the potential paths 30 for the traffic passing between a first network 10a and a second network 10b input by a network administrator for the first network 10a. The database, or datastore, 46 may retain the information in local memory and/or save the aggregate information as a file, or file(s).

One example of such data that may be input, or programmed, 64a may include topology information 68. In some examples, network-topology information 68 may be provided to and/or with the database 46n and/or control-plane module 44c. Such topology information 68 may assist in a determination, by the control-plane module 44c, of alternate routes 30 that may be considered between networks 10. Such network information 68 may define the network devices and network links in the intermediate infrastructure 14 connecting the networks 10 over different potential paths 30 for traffic passing between the networks 68. In such examples, the control-plane module 44 may be further operable to determine the different potential paths 30 from the network-topology information 68.

The topology information 68 may include information about the connections available and/or knowledge of which networks 10 may peer to each other. The topology information 68 may be maintained in a public or private up-to-date database 46. The network-topology information 68 may also be used to correlate data in the database 46 to the network devices and network links in the intermediate infrastructure 14. In some examples, the control-plane module 44 may be further operable to correlate the data to different potential paths 30 for the passing of traffic between the first network 10 and the second network 10.

In some examples, one or more agents 50 may provide topological information 68 about the DIXP 26 and/or other intermediate infrastructure 14 from network devices in the DIXP 26 and/or other intermediate infrastructure 14. By way of example and not limitation, in such examples, network devices in the DIXP 26 and/or other intermediate infrastructure 14 may utilize a form of link-state protocol to both advertise and collect topology information 68, which may later be retrieved by the agents 50. By way of one non-limiting example, in cases where network devices utilize the SPB protocol, a link state protocol in terms of Intermediate System to Intermediate System (IS-IS) may also be applied as part of the SPB protocol for the control plane 52. As can be appreciated, other forms of link state protocols may also be utilized that may also provide topology information 68. The database, or datastore, 46 may also include trigger action information, configuration information, thresholds, and/or other such information discussed below.

Not only may topology information 68 be used to correlate data in the database 46b to the network devices and network links in the intermediate infrastructure 14, but the control-plane module 44c may utilize topology information 68 to inform instructions that the control-plane module 44 may send to agents 50. As stated, the control-plane module 44c may prepare instructions for agents 50 on what tests to run and/or information to collect and/or monitor. The control-plane module 44 may prepare such instructions dynamically and/or in response to previous traffic data, hardware-environment measurements, topology information 68, and/or the like, received from the agents 50, a client computer 54, and/or a third-party system 56.

One or more third party systems 56 may be connected to the control-plane module 44c and/or one or more agents 50 over a link 70 to the communication channel 60. Such a third party system 56 may communicate with the control-plane module 44c and/or one or more agents 50 using one or more industry standard protocols for an Application Programming Interface (API), such as Simple Object Access Protocol (SOAP), REpresentational State Transfer (REST), and/or a custom API. The one or more third party systems 56 may utilize such an API to receive test results, notifications of trigger events, and/or other instructions from to the control-plane module 44c and/or one or more agents 50. Upon receiving such information, a third-party system may perform an action on devices not directly attached to an agent 50.

In some examples, an administrator and/or user may use a client computer 54 to program the control-plane module 44c, over the UI module 64a, such as in terms of instructions and/or tests to be sent to agents 50, event triggers, one or more threshold levels for measurements and/or events about which agents 50 may collect data, and/or the like. Such an administrator, or user, may also receive, by means of the UI module 66, results of tests, notifications of triggered events, updates, and/or other like information reporting on the monitoring and/or collection of data from the client computer 54a. The control-plane module 44c may use thresholds to indicate when the results of a test and/or measurement indicate that an action should be taken by the control-plane module 44c and/or one or more agents 50, and/or what that action should be. Furthermore, an administrator may initiate actions by means of the UI module 66 and/or control-plane module 44c based on those reports, results, and/or the like through the UI module 66.

To assist in the preparation of instructions for agents 50 distributed across the intermediate infrastructure 14, a trigger-handler module 72a may be included within the control module 44c and/or may be communicatively coupled thereto. As with the control-plane module 44c, the trigger-handler module 72a may be programmed 64b via the UI module 66. The trigger-handler module 72a may receive trigger notifications from the agents 50 over the communication channel 60 and/or from the database 46b over one or more links 74a, 74b. Furthermore, the trigger-handler module 72a may determine which thresholds have been met, what notifications to make to agents 50 and/or what actions to take. The control-plane module 44c may then send notifications to a client computer 54, a third-party system 56 and/or agents 70 through the communications channel 60.

Owing to knowledge of the results provided by agents 50, as well as historical data, the control-plane module 44c and/or the trigger-handler module 72a may make informed decisions on when and/or how to initiate an action. For simpler decisions, or if the communication channel 60 between the agents 50 and control-plane module 44c is temporarily down, one or more agents 50 may initiate an action. The control-plane module 44c and/or the trigger-handler module 72a may also be operable to harness current and/or historical data provided to the database/datastore 46b to provide additional information about paths 30 through the intermediate infrastructure 14.

In other words, the database 46b may store updated and/or current values for various relevant metrics, but the database 46b may also archive older values. The interpretation module 76a may, for example, analyze historical data in the database 46a and/or provide interpretations of implications of the historical data for use of the potential paths 30 for the traffic passing between a first network 10a and a second network 10b. In some cases, the interpretation module 76a may harness and/or analyze this historical data to provide additional information to, for example, a client computer 54 and/or a third-party system 56. By way of one non-limiting example, the control-plane module 44c may identify and/or predict network usage over periods of time to determine problems before they occur from historical data in the database 46. Such additional information could also be used, by way of example and not limitation to programmatically increase network throughput based on said identifications and predictions.

By way of an additional non-limiting example, the control-plane module 44c may identify and/or predict patterns in Denial of Service (DoS) attacks 78 by storing information about identified attacks 78 in the database 46b and/or accessing from the database 46b historical data with which to identify such attacks 78, to predict what systems or parts of systems are most susceptible to such attacks 78. Patterns of previous attacks 78, as identified by the control-plane module 44c, can be used to identify weaknesses in the system susceptible to such attacks, as well as to predict where they may come from in the future.

The control-plane module 44c may use one or more metrics to determine that the cause of performance degradation for a path 30 may be due to an attack 78, such as a DoS attack 78. Furthermore, the control-plane module 44c may provide instructions to one or more agents 50 to utilize functionalities of one or more packet analyzers, or sniffers, and/or Local Area Network (LAN) cards at network nodes within a DIXP 26, and/or other aspects of the intermediate infrastructure 14, such as the routers of the previous figure, to collect header information with which performance degradation may be detected and/or identified as caused by an attack 78. Furthermore, identification of attacks 78 may be provided to an administer, user, and/or automated protocol to mitigate the effects of the attack by choosing alternate routes for “good” traffic along uncongested paths 30 and blocking “bad” traffic.

As can be appreciated, therefore, the database 46b and/or the control-plane module 44c may provide relevant information about a system operable to connect independent networks 10 via a DIXP 26 and/or over other paths 30 traversing additional intermediate architecture a network administrator and/or user. This information may provide a means to automate decision making about, among other things, traffic steering and engineering, based on rules and metrics provide one or more administrators and/or users. In some examples, suitable default behaviors may be used by less experienced network administrators.

Consequently, one or more of the disadvantages may be mitigated where the same path 30 is used for reception and delivery of network traffic as long as that path 30 is available. A path 30 through a transit network 16, one of several possible paths 30 through a DIXP 26, a path through a standalone IXP 48, a direct peering connection 24, and/or some other intermediate infrastructure 14 may be judged more optimal at a certain point in time based on metrics of the different paths 30. For example, an automated decision, or a decision made by an administrator and/or user may be made to switch some or all traffic between independent nodes to one or more alternate paths 30 even when the current path 30 is still available, if the performance of the current path 30, or paths 30, based on any number of metrics, is considered “bad enough” for “long enough.” However, before any such determinations may be made, a control-plane module 44 may first aggregate the information supporting such determinations from agents 50.

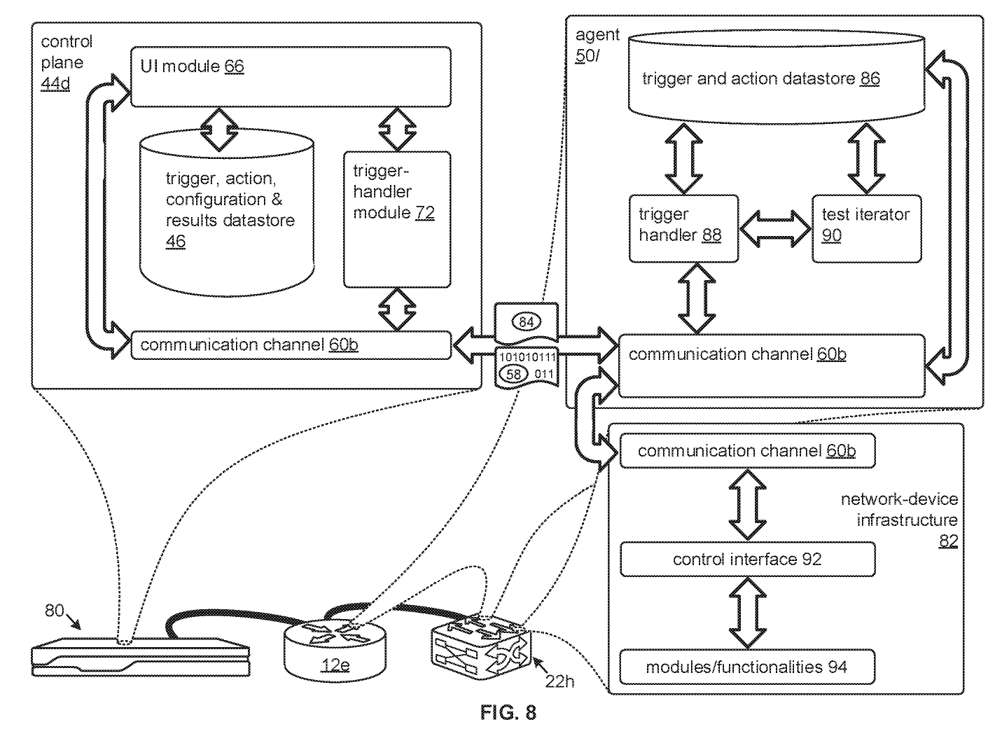

Referring to FIG. 8, a control-plane module 44d on a computing device 80 is depicted, together with an example agent 50l implemented in connection with different potential network devices 12e, 22h. Also depicted is a network-device infrastructure 82 with which information may be gathered on a network device 12e, 22h. The control-plane module 44d may include a database 46c, a UI module 66b, a trigger-handler module 70b, and/or other modules with access to a communication channel 60b shared with the example agent 50l and/or example network-device infrastructure 82. Also, the control-plane module 44d may reside anywhere an agent 50 resides and/or separately on one or more separate computing devices 80.

The control-plane module 44d may provide instructions 84 to one or more agents 50l for data collection over the common communication channel 60b. In some examples, the communications channel 60b may have some connections made through a DIXP 26. However, connections for the communication channel 60b may also be made through the public internet, a Virtual Local Area Network (VLAN), and/or other methods. The one or more agents 50 may also be connected to a hub, switch 22, router 12, virtual router, or other network device through the communication channel 60b.

In communicating instructions 84 to one or more agents 50l, the control-plane module 44d may access and/or program one or more trigger and/or action datastores/databases 86 within and/or communicatively coupled to the one or more corresponding agents 50l and/or connected to the common communication channel 60b. Using this information and/or instructions from datastores/databases 86, the agents 50l may program a corresponding network device, e.g., 12, 22, via the communications channel 60b. In doing so, an agent 50, a trigger handler module 88, and/or an iterator module 90, may access a control interface 92 of the device(s), e.g., 12, 22, with which the agent 50l may access the various network functions 94 of the device(s), e.g., 12, 22. The device(s), e.g., 12, 22, may then monitor and/or analyze traffic and/or run tests for the agent 50l, returning the results back to the agent 50l via the communications channel 60b for inclusion in the datastore/database 86 of the agent 50l.

In some examples, a trigger-handler module 88 and/or an iterator module 90 can be programmed, by the agent 50l and/or the control-plane module 44c, directly and/or indirectly, to repeat the testing, monitoring, and/or analysis once and/or at desired intervals. Such intervals may be linear, or change dynamically in response to various conditions. For example, and without limitation, the iterator module 90 may use progressively longer intervals when part of the communications channel 60b is down to avoid unnecessary traffic being generated when part of the system is not responsive. Active tests may be performed by the trigger-handler module 88 and/or the iterator module 92 and/or may include indirect methods, such as, without limitation, ping and/or traceroute methods, and/or or more direct methods of accessing information.

Examples of more direct methods of accessing information from network devices may employ, without limitation, protocols such as, but not limited to, Simple Network Management Protocol (SNMP) and/or Network Configuration Protocol (NETCONF). The trigger-handler module 88 and/or iterator module 90 may also employ passive tests, such as, without limitation, receiving communication back to the trigger-handler module 88 and/or iterator module 90 utilizing a notification protocol, such as, but not limited to, network configuration protocol (NETCONF), to inform the trigger-handler module 88 and/or iterator module 90 of regular results, where the trigger-handler module 88 and/or iterator module 90 may be programmed to expect such results.

The trigger-handler module 88 and/or iterator module 90 may analyze such results and/or data and/or decide, based on pre-programmed criteria and/or instructions given from the control-plane module 44d, if any thresholds have been crossed. Transgression of one or more of such thresholds may indicate to the agent 50l that the control-plane module 44d, a client computer 54, and/or a third-party system 56 require a notification. The agent 50l may provide the notification(s) and/or perform a corresponding action.

As depicted, an agent 50l, trigger-handler module 88, and/or iterator module 90 may communicate with a network-device infrastructure 82 for a network device/node to execute tests on, give instructions 84 to, and/or collect data from the corresponding network device/node 12, 22, and/or set 82 of functionalities, initially and/or as a result of those tests and/or triggered events, autonomously, or as directed by the control-plane module 44d. In some examples, instructions 84 to the devices may also come directly from the control-plane module 44d through the communications channel 60b. An agent 50l may reside as a software module on the devices, e.g., 12, 22, themselves and/or on separate computing infrastructure.

The control-plane module 44d may provide instructions to one or more agents 50 for data collection over the common communication channel 60b. Within the instructions, the control-plane module 44d may include a set of thresholds for values corresponding to metrics at which data collected by the agents 50 should be reported to the control-plane module 44d over the common communication channel 60b. The depicted network devices 12e, 22h may pertain to a larger system of intermediate network elements 14 that may provide different routes 30 between networks 10.

Also, within the system, agents 50 may be distributed across the intermediate network elements 14, which may collect data with which the different routes 30 between networks 10 may be assessed, or monitored. In the system, a DIXP 26 may contribute at least a portion of the intermediate network elements 14. The DIXP 26 may facilitate a peering relationship between two or more networks 10. The control-plane module 44 may be operable to receive data from reports 58 from the agents 50 and/or store the data in the centralized database 46.

Hence, the control-plane module 44c and the agents 50 may, together, collect data on different metrics for different paths 30 through the intermediate network elements 14 between two or more networks 10. In some examples, one or more paths 30 for which the data is collected may traverse a transit network 16. The transit network 16 may require transit payments to provide a path 30 for traffic between a first network 10 and a set of networks 10. As discussed above, the paths 30 many different types of intermediate infrastructure 14 that may also have unique metrics for collecting data and/or monitoring.

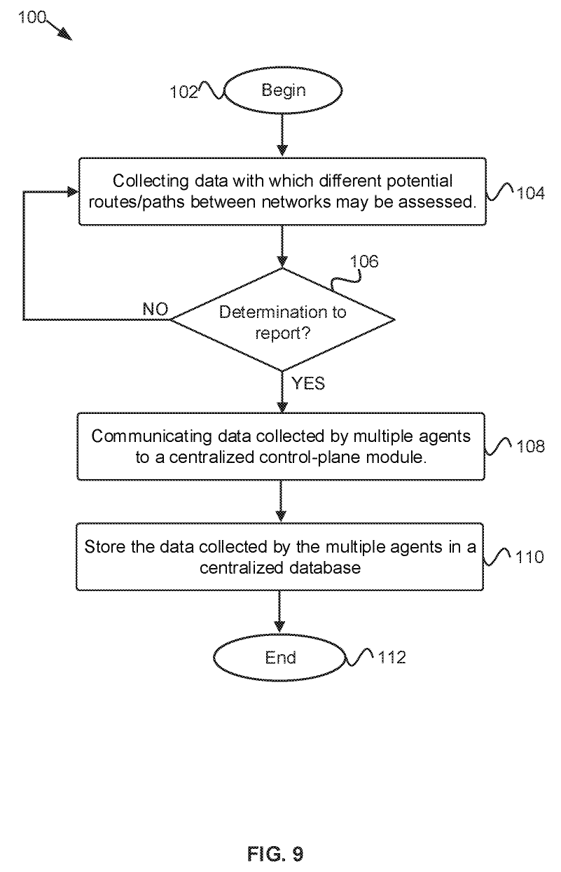

Referring to FIG. 9, a series of steps and determination points are depicted, as a flowchart, for exemplary methods for monitoring different potential paths 30 between networks 10. The flowcharts in FIG. 9 illustrate the architecture, functionality, and/or operation of possible implementations of systems, methods, and computer program products according to examples. In this regard, each block in the flowcharts may represent a module, segment, or portion of code, which comprises one or more executable instructions for implementing the specified logical function(s). It will also be noted that each block of the flowchart illustrations, and combinations of blocks in the flowchart illustrations, may be implemented by special purpose hardware-based systems that perform the specified functions or acts, or combinations of special purpose hardware and computer instructions.

Where computer program instructions are involved, these instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block or blocks. These computer program instructions may also be stored in a computer readable medium that may direct a computer to function in a particular manner, such that the instructions stored in the computer-readable medium produce an article of manufacture including instruction means which implement the function/act specified in the flowchart and/or block or blocks. The computer program may also be loaded onto a computer to cause a series of operation steps to be performed on the computer or other programmable apparatus to produce a computer implemented process for the functions/acts specified in the flowchart and/or block or blocks.

It should also be noted that, in some alternative implementations, the functions noted in the blocks may occur out of the order noted. In certain embodiments, two blocks shown in succession may, in fact, be executed substantially concurrently, or the blocks may sometimes be executed in the reverse order, depending upon the functionality involved. Alternatively, certain steps or functions may be omitted.

In FIG. 9, methods 100 may begin 102 by multiple agents 50 communicatively coupled to multiple network elements, providing different potential routes 30 between networks 10, collecting 104 data with which different potential paths 30 between networks 10 may be assessed. In some examples, the data may be analyzed with respect to one or more thresholds and/or other criteria to make a determination 112 to report on the data or not.

Where the determination is no 106, methods 100 may return to collecting 104 data. Where the determination is yes, the methods may proceed to communicating 108 data collected by multiple agents 50 to a centralized control-plane module 44. The control-plane-module 44 may store 110 the data collected by the multiple agents 50 in a centralized database 46 and the methods 100 may end 112. In some examples, methods 100 may skip the determination 106 and proceed directly to communicating 108 the data to the control-plane module 44.

Methods 100 may also include generating instructions 84, by the control-plane module 44, for the collection of data with which to assess different routes/paths 30 traversing network elements 14 between networks 10. Such methods may also include the control-plane module 44 sending the instructions 84 to the multiple agents 50 within the control plane 52. The multiple agents 50 may then execute the instructions 84 to collect the data.

Some exemplary methods 100 may further include the control-plane module 44 identifying patterns of network usage from historical data in the database 46. Additionally, such methods 100 may include the control-plane module 44 predicting future network usage at network elements 14 between networks 10. Along such lines, in some methods 100, the control-plane module 44 may identify patterns of DoS attacks 78 from historical data in the database 46. The control-plane module 44 may further predict a likelihood for future DoS attacks 78 affecting network elements 14 between independent/AS networks 10. The control-plane module 44 may also detect current attacks 78 hampering one or more routes/paths 30 between independent/AS networks 10 by analyzing data in the database 46.

In such exemplary methods 100, one or more paths 30, from the different potential paths 30, may traverse a DIXP 26. Such a DIXP 26 may be operable to facilitate a peering relationship between one or more networks 10. Additional potential paths 30, may traverse intermediate infrastructure 14 separate from the DIXP 26.

The present disclosures may be embodied in other specific forms without departing from their spirit or essential characteristics. The described examples are to be considered in all respects only as illustrative, not restrictive. The scope of the invention is, therefore, indicated by the appended claims, rather than by the foregoing description. All changes within the meaning and range of equivalency of the claims are to be embraced within their scope.

1. A system for data collection for potential traffic paths between networks, comprising:
a database, on a physical storage medium, operable to maintain data correlated to network elements having a potential to facilitate traffic passing between a first network and a second network, the network elements outside of the first network and the second network;
a set of agents coupled to the network elements, the set of agents operable to carry out instructions to collect data from the network elements relevant to evaluation of potential paths for the traffic passing between the first network and the second network; and
a control-plane module coupled to the database and the set of agents, operable to:
provision the instructions to the set of agents; and
store the data received from the set of agents in the database.

2. The system of claim 1, wherein the control-plane module is further operable to correlate the data to different potential paths for the traffic passing between the first network and the second network, the first network pertaining to an Autonomous System (AS) network and the second network pertaining to an AS network.

3. The system of claim 2, wherein at least a subset of the set of agents is further operable to collect measurements relevant to hardware health for hardware correlated to the different potential paths for the traffic passing between the first network and the second network.

4. The system of claim 2, further comprising network-topology information in the database defining the network elements and network links connecting the network elements between the first network and the second network from which the different potential paths for the traffic passing between the first network and the second network may be determined, the control-plane module further being operable to determine the different potential paths from the model in the database.

5. The system of claim 2, wherein at least one potential path for which data is collected is a path through a Distributed Internet Exchange Platform (DIXP) enabling a peering relationship for the traffic passing between the first network at a first geographic location and the second network at a second geographic location remotely located relative to the first geographic location.

6. The system of claim 2, wherein the control-plane module and the set of agents are operable to monitor the different potential paths by continually updating the instructions, collecting the data, and storing the data in the database.

7. The system of claim 3, wherein the control-plane module is further operable to:
provide instructions to the set of agents coupled to the network elements, operable to facilitate multiple different potential paths from the first network through the DIXP, to collect data monitoring the multiple different potential paths through the DIXP; and
update the database with the data about the multiple different potential paths collected by the set of agents.

8. The system of claim 3, further comprising an interpretation module coupled to the control-plane module and operable to analyze historical data in the database and to provide interpretations of implications of the historical data for use of the potential paths for the traffic passing between the first network and the second network.

9. The system of claim 3, wherein at least one potential path for which data is collected is a path providing an alternative to the at least one path through the DIXP.

10. The system of claim 4, further comprising an additional input module coupled to the control-plane module and operable to receive data relevant to the evaluation for the potential paths for the traffic passing between the first network and the second network input by a client computer.

11. A method for monitoring different potential routes between two Autonomous Systems (AS) comprising:
collecting, by multiple agents coupled to multiple network elements providing different potential routes between two ASs, data with which the different potential routes may be assessed;
communicating the data collected by the multiple agents to a centralized control-plane module; and
storing, by the control-plane module, the data collected by the multiple agents in a centralized database.

12. The method of claim 11, further comprising:
generating instructions, by the control-plane module, for the collection of data with which to assess different routes traversing the network elements between the two autonomous system networks;
sending, by the control-plane module, the instructions to the multiple agents within the control plane; and
executing, by the multiple agents, the instructions to collect the data.

13. The method of claim 12, wherein at least one route, from the different potential routes, traverses a Distributed Internet Exchange Platform (DIXP) operable to facilitate a peering relationship between the two ASs.

14. The method of claim 12, further comprising:
identifying, by the control-plane module, patterns of network usage from historical data in the database; and
predicting, by the control-plane module, future network usage at network elements between two ASs.

15. The method of claim 12, further comprising detecting a Denial of Service (DoS) attack, by analyzing the data in the database, the DoS attack hampering at least one route between the two ASs.

16. The method of claim 14, further comprising:
identifying, by the control-plane module, patterns of DoS attacks from historical data in the database; and
predicting, by the control-plane module, a likelihood for future DoS attacks affecting network elements between the two ASs.

17. A system for monitoring different traffic paths traversing intermediate infrastructure between networks comprising:
intermediate network elements operable to provide different routes between two networks;
a Distributed Internet Exchange Platform (DIXP) contributing at least a portion of the intermediate network elements and operable to facilitate a peering relationship between the two networks;
agents distributed across the intermediate network elements and operable to collect data with which the different routes between the two networks may be assessed; and
a control-plane module operable to receive data from the agents and store the data in a centralized database.

18. The system of claim 17, wherein at least one route for which the data is collected traverses a transit network which requires payments to provide a route for traffic between a first network and a set of networks including a second network, the two networks comprising the first network and the second network.

19. The system of claim 17, wherein the control-plane module and the agents are operable to collect data on different metrics for different paths through the intermediate network elements and the two networks.

20. The system of claim 17 wherein the control-plane module is further operable to:
provide instructions to the agents for data collection over a common communication channel; and
including, in the instructions, a set of thresholds for values of corresponding to metrics at which data collected by the agents should be reported to the control-plane module over the common communication channel.
